(19) United States
(12) Patent Application Publication
(10) Pub. No.: US 2006/0208636 A1
(43) Pub. Date: Sep. 21, 2006

(54) Plasma display panel

(76) Inventor: Tae-Joung Kweon, Suwon-si (KR)

Correspondence Address: Robert E. Bushnell;Suite 300, 1522 K Street, N.W., Washington, DC, 20005, US

(21) Appl. No.: 11/369,858

(22) Filed: Mar. 8, 2006

(30) Foreign Application Priority Data
Mar. 17, 2005 (KR) 10-2005-0022206

(51) Int. Cl. G09G 3/28; H01J 61/00

(52) U.S. Cl. 313/567; 345/60

(57) ABSTRACT

A plasma display panel (PDP) includes front and rear substrates arranged so as to face each other, first and second complementary color films arranged so as to be parallel with the front and rear substrates, barrier ribs for partitioning a plurality of discharge cells at a space between the front and rear substrates, an address electrode formed and extending along one direction so as to correspond to each discharge cell, a phosphor layer formed within the discharge cell, a display electrode, and a dielectric layer covering the display electrode. The first and second complementary color films have colors which have a mutually complementary color relationship. The display electrode corresponds to each discharge cell, and extends in a direction intersecting the direction of the address electrode.

### CLAIM OF PRIORITY

This application makes reference to, incorporates the same herein, and claims all benefits accruing under 35 U.S.C. §119 from an application for PLASMA DISPLAY PANEL, earlier filed in the Korean Intellectual Property Office on the 17^{th} Mar. 2005 and there, duly assigned Serial No. 10-2005-0022206.

### BACKGROUND OF THE INVENTION

1. Technical Field

The present invention relates to a plasma display panel, and more particularly to a plasma display panel for reducing reflection of external light, thereby improving contrast.

2. Related Art

In recent years, apparatuses using the plasma display panel (hereinafter, referred to as “PDP”) has been highlighted as the next generation of large-sized flat displays. Such PDPs is have excellent characteristics of a large screen, high definition, ultra-thinness, light weight, and wide viewing angle. Furthermore, PDPs are simply manufactured and are easier to produce as a large screen in comparison to other flat type displays.

PDPs are classified as direct current (DC) types, alternating current (AC) types, and hybrid types depending on the applied discharge voltage, and are classified as opposing discharge types and surface discharge types depending on discharge configuration.

In the DC type PDP, all electrodes are exposed to a discharge space, and electric charge is directly transferred between corresponding electrodes. In the AC type PDP, at least one electrode is surrounded by a dielectric layer, and electric charge is not directly transferred between corresponding electrodes, but rather discharge is performed using wall charge.

In the DC type PDP, charge is directly transferred between corresponding electrodes, and accordingly there is a problem in that the electrodes are significantly damaged. In order to solve the aforementioned problem, an AC type of PDP having a three-electrode surface discharge structure has been recently adopted.

A surface discharge type PDP, including the three-electrode surface discharge AC type PDP, includes a front substrate and a rear substrate, and has a construction in which electrodes are buried within a dielectric material.

An address electrode, a rear substrate dielectric layer, barrier ribs, and a phosphor layer are formed at the rear substrate. The address electrode generates an address discharge together with a scan electrode. The rear substrate dielectric layer is formed on the rear substrate so as to cover the address electrode. The barrier ribs partition a plurality of discharge cells. A phosphor layer is formed at both sides of each barrier rib, and on the rear substrate where the barrier ribs are not formed.

In addition, the front substrate is spaced away from and faces the rear substrate.

A pair of electrodes for generating a sustain discharge, a front substrate dielectric layer having the electrodes buried therein, and a protective film are provided at the front substrate.

In a PDP having the above construction, it is required to improve the expression of color tone so as to improve the quality of the PDP. A typical method of enhancing the expression of color tone in the PDP is to maximize emission luminance of the discharge cell. However, contrast is not determined simply by a maximum value of luminance. It is also related to a contrast of brightness and darkness which is perceived when a person recognizes the color tone through his/her optic nerve.

Therefore, in another method developed in consideration of the above, the reflection of external light is reduced. That is, while the PDP displays an image, external light supplied to the PDP can be minimized, thereby clearly realizing a color sense.

One of the methods that are under development in consideration of the above is a method of additionally forming a black colored layer along a non-discharge area of the PDP.

The above information is disclosed only for enhancement of an understanding of the background of the invention, but does not necessarily constitute prior art known to a person of ordinary skill in the art.

### SUMMARY OF THE INVENTION

The present invention has been developed in an effort to provide a plasma display panel having the advantage of easily reducing the reflection of external light without a great change in the manufacturing process, thereby improving contrast.

An exemplary plasma display panel according to an embodiment of the present invention includes front and rear substrates arranged so as to face each other, first and second complementary color films arranged so as to be parallel to the front and rear substrates, barrier ribs for partitioning a plurality of discharge cells at a space between the front and rear substrates, an address electrode formed and extending in one direction so as to correspond to each discharge cell, a phosphor layer formed within the discharge cell, a display electrode, and a dielectric layer covering the display electrode. The first and second complementary color films have colors which have a mutually complementary color relationship. The display electrode corresponds to each discharge cell, and extends in a direction intersecting the direction of the address electrode.

The first complementary color film may be formed on a front surface of the front substrate, and the second complementary color film may be formed on a rear surface of the front substrate.

The display electrode is layered on the second complementary color film. The first complementary color film may be formed on the front surface of the front substrate, and the second complementary color film maybe spaced apart from the front substrate between the front and rear substrates.

The first and second complementary color films may be disposed between the front and rear substrates. In this case, the barrier ribs may be transparent barrier ribs.

The plasma display panel may be partitioned into a display area which displays an image and a non-display area which does not display the image, and the first and second complementary color films may be formed in the display area.

Colors having a complementary color relationship may be mixed with each other so as to become an achromatic color, preferably a gray color.

A plasma display panel according to another exemplary embodiment of the present invention may include a third complementary color film formed on the front substrate so as to be parallel to the front substrate.

The third complementary color film transmits visible light, which is radiated from the discharge cell to the front substrate, and absorbs external light reflected from the front substrate.

The third complementary color film may have a color which has a complementary color relationship with a color of at least one layer formed between the front and rear substrates.

Colors having a complementary color relationship may be mixed with each other so as to become a gray color.

The third complementary color film may have a color which has a complementary color relationship with a color of the first dielectric layer covering the display electrode.

The third complementary color film may have a color which has a complementary color relationship with a color of the second dielectric layer covering the address electrode.

A fourth complementary color film may be provided between the front and rear substrates, and the third complementary color film and the fourth complementary color film may have a mutually complementary color relationship.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view showing a plasma display panel (PDP) according to a first exemplary embodiment of the present invention;

FIG. 2 is a partially cross-sectional view taken along the line II-II of FIG. 1;

FIG. 3 is a view illustrating a PDP which is partitioned into a display area which displays an image and a non-display area which does not display an image;

FIG. 4 is a partially cross-sectional view showing a PDP according to a second exemplary embodiment of the present invention;

FIG. 5 is a partially cross-sectional view showing a PDP according to a third exemplary embodiment of the present invention;

FIG. 6 is a partially cross-sectional view showing a PDP according to a fourth exemplary embodiment of the present invention; and

FIG. 7 is a partially cross-sectional view showing a PDP according to a fifth exemplary embodiment of the present invention.

### DETAILED DESCRIPTION OF THE INVENTION

An embodiment of the present invention will hereinafter be described in detail with reference to the accompanying drawings. The present invention may, however, be embodied in different forms and should not be construed as limited to the exemplary embodiment set forth herein.

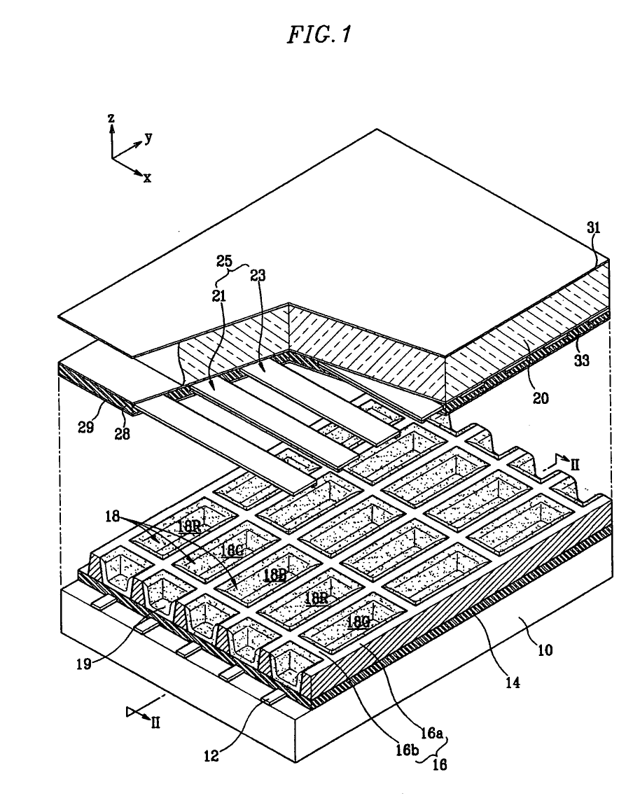

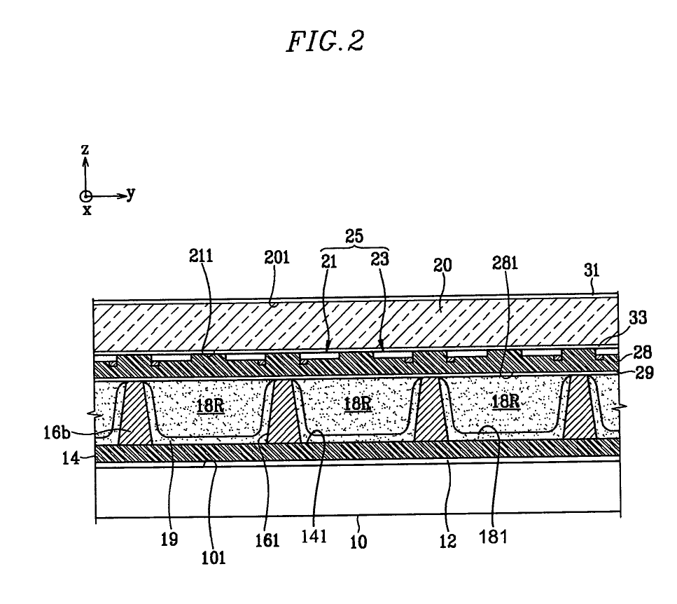

FIG. 1 is an exploded perspective view showing a plasma display panel (PDP) according to a first exemplary embodiment of the present invention, and FIG. 2 is a partially cross-sectional view taken along the line II-II of FIG. 1.

Referring to FIGS. 1 and 2, in the PDP of the first exemplary embodiment, a rear substrate 10 and a front substrate 20 are arranged so as to be spaced apart from and facing each other. Color-based discharge cells 18 (18R, 18G, and 18B) are partitioned using barrier ribs 16 in a space between the rear substrate I0 and front substrate 20. Furthermore, a phosphor layer 19 is formed in each discharge cell 18. In more detail, the phosphor layer 19 is formed on side surfaces 161 of the barrier ribs 16, and on bottom surfaces 181 of the discharge cells 18.

The phosphor layer 19 is excited by vacuum ultraviolet rays to radiate visible light. The discharge cells 18 are filled with a discharge gas for generating a plasma discharge. The discharge gas includes a mixture of xenon (Xe) and neon (Ne).

The front substrate 20 is formed of a transparent material, such as glass. Accordingly, the front substrate 20 transmits visible light, thereby displaying an image.

A first complementary color film 31 and a second complementary color film 33, which have colors which have a mutually complementary color relationship, are further formed on the front substrate 20. The first and second complementary color films 31 and 33, respectively, absorb external light from the exterior of the PDP, thereby reducing the reflection of external light. A detailed description thereof will be given later.

Display electrodes 25 are formed on a rear surface of the front substrate 20 so as to correspond to each discharge cell 18 along one direction. (X-axis direction in FIGS. 1 and 2) Each display electrode 25 functionally comprises a scan electrode 21 and a sustain electrode 23. The scan electrode 21 interacts with an address electrode 12 so as to select a discharge cell 18 to be turned on, and the sustain electrode 23 interacts with the scan electrode 21 so as to generate a sustain discharge at the selected discharge cell 18.

The display electrodes 25 are covered with a dielectric layer 28, which is formed of a dielectric material, such as PbO, B₂O₃, or SiO₂. The dielectric layer 28 prevents charged particles from directly colliding with and damaging the display electrodes 25 during discharge, and collects the charged particles.

A lower surface 281 of the dielectric layer 28 can be covered with a protective film 29, which is formed of magnesium oxide (MgO). The protective film 29 prevents the charged particles from directly colliding with and damaging the dielectric layer 28 during discharge. Furthermore, when the charged particles collide with the protective film 29, secondary electrons are emitted, thereby improving the efficiency of discharge.

The address electrodes 12 are formed on a front surface 101 of the rear substrate 10 facing the front substrate 20. The address electrodes 12 respectively extend in one direction (Y-axis direction in FIGS. 1 and 2) intersecting a direction of the display electrodes 25, and are arranged so as to correspond to each discharge cell 18 with a predetermined gap therebetween. The address electrodes 12 are covered and buried by the dielectric layer 14, and the barrier ribs 16 are formed on the dielectric layer 14 so as to have a predetermined pattern.

The barrier ribs 16 partition the discharge cells 18 wherein discharge occurs. This prevents crosstalk between adjacent discharge cells 18. In the present exemplary embodiment, each barrier rib 16 is formed so as to have a closed structure having a longitudinal barrier rib 16a and a transverse barrier rib 16b. In other words, the barrier ribs 16 include the longitudinal barrier ribs 16a which are spaced apart from each other and which extend in one direction (the Y-axis direction in FIG. 1), and the transverse barrier ribs 16b which are spaced apart from each other and which extend in a direction intersecting the longitudinal barrier ribs 16a. The aforementioned structure of the barrier ribs 16 is a preferable exemplary embodiment. Accordingly, it is of course possible that variously shaped barrier ribs, such as stripe-type barrier ribs, can be disposed between the address electrodes so as to be in parallel with the address electrodes 12.

A phosphor layer 19 is formed in each discharge cell 18. The phosphor layer 19 is excited by vacuum ultraviolet rays generated during discharge, and transitions to a ground state, thereby radiating visible light. As shown in FIG. 2, the phosphor layer 19 is formed on side surfaces 161 of the barrier ribs 16 and on an upper surface 141 of the dielectric layer 14 defined by the barrier ribs 16. The phosphor layer 19 can be formed using red, green or blue phosphors to represent color. Accordingly, the phosphor layer 19 is classified into red, green, and blue phosphor layers 18R, 18G and 18B, respectively. As described above, the discharge gas, such as a mixture of neon (Ne) and xenon (Xe), is deposited in the discharge cells 18 wherein the phosphor layers 19 are formed.

Referring to FIG. 2, the first and second complementary color films 31 and 33, respectively, are further provided on the front substrate 20 of the PDP according to the present exemplary embodiment. The display electrodes 25, the dielectric layer 28 covering the display electrodes 25, and the protective film 29 are sequentially formed in a direction extending from the front substrate 20 to the rear substrate 1O.

In more detail, the PDP according to the present exemplary embodiment further includes the first and second complementary color films 31 and 33, respectively, on the front surface 201 and on the rear surface 211, respectively, of the front substrate 20. In other words, the first complementary color film 31 is formed on the front surface 201 of the front substrate 20, and the second complementary color film 33 is formed on the rear surface 211 of the front substrate 20. The display electrodes 25 are formed on the second complementary color film 33, the dielectric layer 28 is formed so as to bury the display electrodes 25, and the protective film 29 is layered on the dielectric layer 28.

In addition to the first and second complementary color films 31 and 33, respectively, one or more third complementary color films (not shown) can be further disposed between the front substrate 20 and the rear substrate 10. In this case, colors of the first to third complementary color films are mixed with one another to become an achromatic color, preferably a gray color.

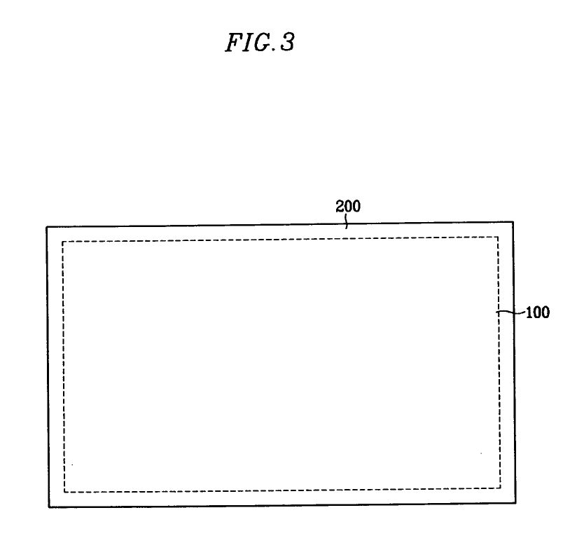

FIG. 3 is a view illustrating a PDP which is partitioned into a display area which displays an image and a non-display area which does not display an image

As shown in FIG. 3, the PDP is substantially partitioned into a display area 100 which displays an image, and a non-display area 200 which does not display an image. It is preferable that the first and second complementary color films 31 and 33, respectively, be formed in the display area 100.

The first and second complementary color films 31 and 33, respectively, have colors having a mutually complementary color relationship. That is, the first and second complementary color films 31 and 33, respectively, have colors that are complementary with each other. For example, the first complementary color film 31 can be a red color, and the second complementary color film 33 can be a green color.

As described above, the first and second complementary color films 31 and 33, respectively, provided at the front and rear surfaces 201 and 211, respectively, of the front substrate 20 have a mutually complementary color relationship, and therefore the front substrate 20 substantially represents the achromatic color. It is preferable that the achromatic color resulting from a combination of the first and second complementary color films 31 and 33, respectively, be a gray color.

When colors having a mutually complementary color relationship are mixed with each other, they become white, black or gray colors. When the front substrate 20 represents the white color, reflection of the external light is undesirably increased. The black color reduces the reflection of the external light, but also absorbs visible light from the PDP. Accordingly, there is a disadvantage in that the emission luminance is reduced. As a result, the gray color, which is capable of allowing the transmission of the visible light and also selectively absorbing the external light, is most preferable.

As such, the first and second complementary color films 31 and 33, respectively, having the mutually complementary color relationship are provided at the front substrate 20 so that the visible light generated during discharge can be emitted through the front substrate 20 without reduction of transmittance. The first and second complementary color films 31 and 33, respectively, interact with each other, thereby preventing external light from being reflected from the front substrate 20 and improving bright room contrast.

The first and second complementary color films 31 and 33, respectively, can be formed using a printing method. That is, a color pigment is mixed with a paste for forming a complementary color film, and the paste is printed and dried to form a thin film on the front surface 201 of the front substrate 20, thereby forming the first complementary color film 31.

Next, a color pigment, which has a complementary color relationship with the color of the first complementary color film 31, is mixed with a paste, and the paste is printed and dried to form a thin film on the rear surface 211 of the front substrate 20, thereby forming the second complementary color film 33.

After that, the display electrodes 25, the dielectric layer 28, and the protective film 29 are formed on the second complementary color film 33.

Hereinafter, various exemplary embodiments of the present invention will be described. Construction of the following exemplary embodiments is similar to or the same as that of the first exemplary embodiment, and therefore detailed descriptions thereof will be omitted, and only descriptions of different parts will be given.

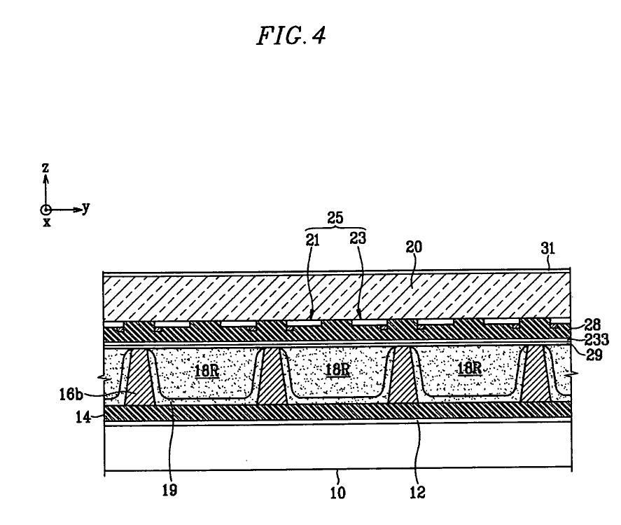

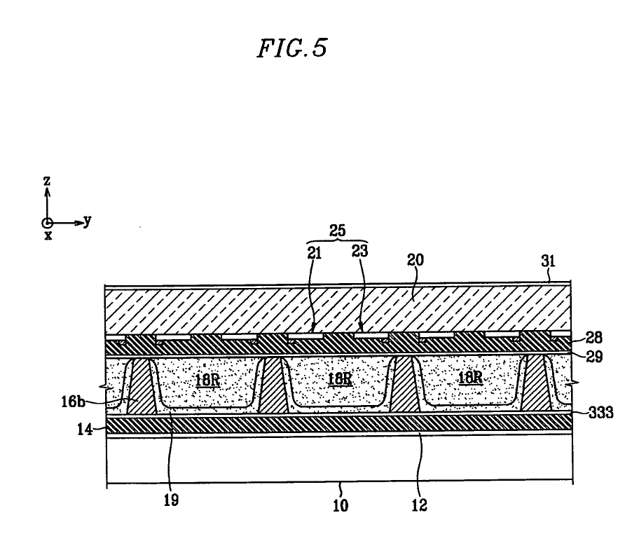

FIG. 4 is a partially cross-sectional view showing a PDP according to a second exemplary embodiment of the present invention, and FIG. 5 is a partially cross-sectional view showing a PDP according to a third exemplary embodiment of the present invention.

Referring to the drawings, in the second exemplary embodiment of FIG. 4, a second complementary color film 233 is formed on dielectric layer 28 covering the display electrodes 25. In the third exemplary embodiment of FIG. 5, a second complementary color film 333 is formed on dielectric layer 14 covering address electrodes 12. However, it is not intended to limit the position of the second complementary color films 233 and 333 to that shown in the exemplary embodiments, and the second complementary color films 233 and 333 can be disposed at any predetermined position between the front substrate 20 and the rear substrate 10.

In the third exemplary embodiment of FIG. 5, the second complementary color film 333 is disposed at a rear substrate 10, and it is preferable that barrier ribs 16 be formed of a transparent material. Accordingly, the first and second complementary color films 31 and 333, respectively, having a complementary color relationship can efficiently interact with each other.

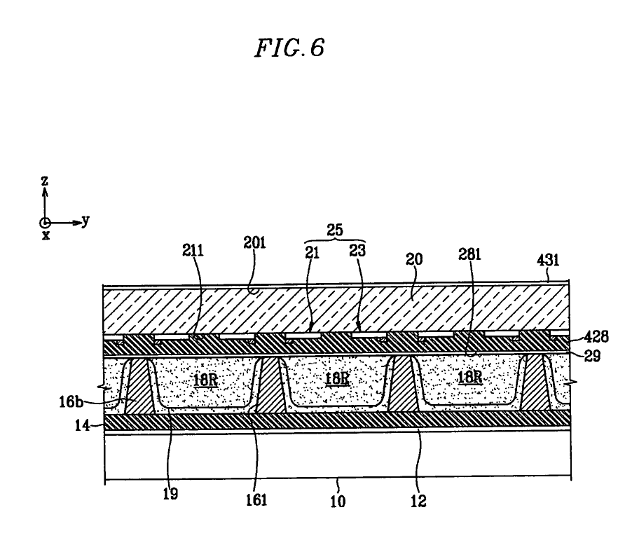

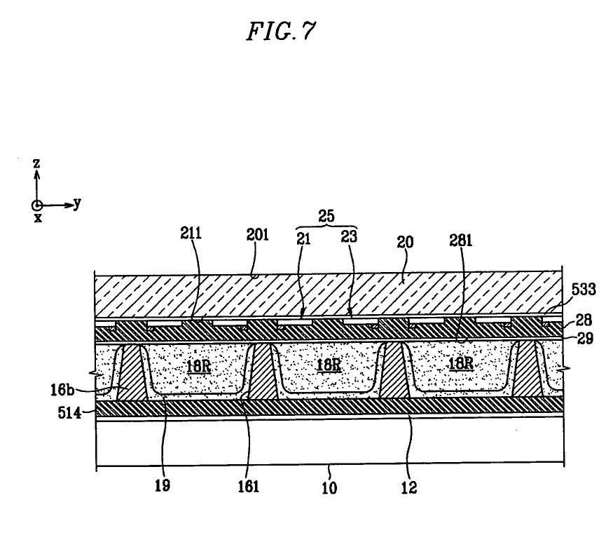

FIG. 6 is a partially cross-sectional view showing a PDP according to a fourth exemplary embodiment of the present invention, and FIG. 7 is a partially cross-sectional view showing a PDP according to a fifth exemplary embodiment of the present invention.

Unlike the first to third exemplary embodiments, a complementary color film is provided on only one surface of a front substrate 20 in the fourth and fifth exemplary embodiments.

That is, in the fourth exemplary embodiment of FIG. 6, a first complementary color film 431 is formed on a front surface 201 of the front substrate 20. The first complementary color film 431 has a mutually complementary color relationship with a dielectric layer 428 covering display electrodes 25.

In the fifth exemplary embodiment of FIG.7, a second complementary color film 533 is formed on a rear surface 211 of the front substrate 20. The second complementary color film 533 has a mutually complementary color relationship with a dielectric layer 514 covering address electrodes 12.

In the fourth and fifth exemplary embodiments, the first complementary color film 431 or the second complementary color film 533 can also be colored so as to have a complementary color relationship with a predetermined layer disposed between the front substrate 20 and the rear substrate 10.

Compared to the first to third exemplary embodiments, in the fourth and fifth exemplary embodiments, the PDP has an advantage in that processes for patterning the complementary color films 431 and 533 can be reduced in number by using a single complementary color film. Furthermore, the complementary color films 431 and 533 formed at the front substrate 20 can have a mutually complementary color relationship with a predetermined layer disposed between the front substrate 20 and the rear substrate 10, thereby more easily improving the contrast.

According to the exemplary embodiments of the present invention, the PDP absorbs external light through the colored complementary color film, thereby minimizing deterioration of luminance and improving the contrast of the PDP. Furthermore, the colored barrier ribs (or a compensation layer) can compensate for a color loss resulting from the complementary color film, thereby preventing deterioration of saturation of a specific color, and more greatly enhancing resolution of the PDP.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display panel, comprising:
front and rear substrates arranged so as to face each other;
first and second complementary color films arranged so as to be in parallel with the front and rear substrates, and having colors which have a mutually complementary color relationship;
a barrier rib for partitioning a plurality of discharge cells at a space between the front and rear substrates;
an address electrode formed and extending in one direction so as to correspond to each discharge cell;
a phosphor layer formed within the discharge cell;
a display electrode formed so as to correspond to each discharge cell, and extending in a direction which intersects said one direction of the address electrode; and
a dielectric layer covering the display electrode.

2. The panel of claim 1, wherein the first complementary color film is formed on a front surface of the front substrate, and the second complementary color film is formed on a rear surface of the front substrate.

3. The panel of claim 2, wherein the display electrode is layered on the second complementary color film.

4. The panel of claim 1, wherein the first complementary color film is formed on a front surface of the front substrate, and the second complementary color film is spaced apart from the front substrate and is formed between the front and rear substrates.

5. The panel of claim 1, wherein the first and second complementary color films are disposed between the front and rear substrates.

6. The panel of claim 5, wherein the barrier rib comprises a transparent barrier rib.

7. The panel of claim 1, wherein the plasma display panel is partitioned into a display area which displays an image and a non-display area which does not display the image; and
wherein the first and second complementary color films are formed in the display area.

8. The panel of claim 1, wherein the colors which have the complementary color relationship are mixed with each other so as to become an achromatic color.

9. The panel of claim 8, wherein the colors which have the complementary color relationship are mixed with each other so as to become a gray color.

10. A plasma display panel, comprising:
front and rear substrates arranged so as to face each other;
a barrier rib for partitioning a plurality of discharge cells at a space between the front and rear substrates;
an address electrode formed and extending in one direction so as to correspond to each discharge cell;
a phosphor layer formed within the discharge cell;
a display electrode formed so as to correspond to each discharge cell, and extending in a direction which intersects said one direction of the address electrode;
a first dielectric layer covering the display electrode; and
a first complementary color film formed on the front substrate so as to be in parallel with the front substrate.

11. The panel of claim 10, wherein the first complementary color film transmits visible light which is radiated from the discharge cell to the front substrate, and absorbs external light reflected from the front substrate.

12. The panel of claim 10, wherein the first complementary color film has a color which has a complementary color relationship with a color of at least one layer formed between the front and rear substrates.

13. The panel of claim 12, wherein the colors which have the complementary color relationship are mixed with each other so as to become a gray color.

14. The panel of claim 12, wherein the first complementary color film has a color which has a complementary color relationship with a color of the first dielectric layer.

15. The panel of claim 12, further comprising a second dielectric layer which covers the address electrode; and
wherein the first complementary color film has a color which has a complementary color relationship with a color of the second dielectric layer.

16. The panel of claim 10, further comprising a second complementary color film provided between the front and rear substrates, wherein the first complementary color film and the second complementary color film have a mutually complementary color relationship.
